(19) United States
(12) Patent Application Publication
(10) Pub. No.: US 2005/0083417 A1
(43) Pub. Date: Apr. 21, 2005

(54) System and method for providing image orientation information of a video clip

(76) Inventors: Amy E. Battles, Windsor, CO (US); Michelle M. Ogg, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,194

(22) Filed: Oct. 21, 2003

(51) Int. Cl. H04N 5/76

(52) U.S. Cl. 348/231.6

(57) ABSTRACT

A system and method for providing orientation information for a frame of a video clip is described. One embodiment comprises capturing an image with an image capture device, generating a frame having at least image data corresponding to the captured image and sequence data indicative of a frame position in the video clip, sensing an orientation of the image capture device at the time the image is captured and incorporating the orientation information corresponding to the sensed orientation into the frame.

### BACKGROUND

Digital image capture devices are configured to capture images that are stored in a memory device as digital information. The orientation of the captured image initially corresponds to the orientation of the image sensor, such as a charge coupled device (CCD) or the like, because the image sensor is physically fixed in position within the digital image capture device. When the digital image capture device is held by the user in an “upright” position, such that the top portion of the CCD corresponds to the top portion of the image to be captured, the captured image when viewed on a display will be properly oriented on the display. That is, the top of the captured image will be displayed at the top of the display. However, the user of the digital image capture device may on occasion choose to capture the image when the digital image capture device is oriented in a “non-upright” position.

Some digital image capture devices have systems for recording orientation information associated with the capture of still images, for example U.S. Pat. No. 6,563,535, Image Processing System For High Performance Digital Imaging Devices; U.S. Pat. No. 5,764,535, Image Authentication Patterning; U.S. Pat. No. 6,532,039, System and Method For Digital Image Stamping; U.S. Pat. No. 6,275,269, Positioning Stamps In Images Captured With An Image Capture Unit; U.S. Pat. No. 6,011,585, Apparatus And Method For Rotating The Display Orientation Of A Captured Image; and U.S. Pat. No. 6,476,863, Image Transformation Means Including User Interface.

### SUMMARY

One embodiment of the invention comprises capturing an image with an image capture device, generating a frame having at least image data corresponding to the captured image and sequence data indicative of a frame position in the video clip, sensing an orientation of the image capture device at the time the image is captured and incorporating the orientation information corresponding to the sensed orientation into the frame.

Another embodiment comprises receiving a frame having at least image data and sequence data corresponding to an image captured by an image capture device, receiving orientation information residing in the frame, determining an orientation of the frame, wherein the orientation of the frame corresponds to the orientation of the image capture device at the time the image was captured and displaying the frame oriented in accordance with the determined orientation.

### BRIEF DESCRIPTION OF THE DRAWINGS

The components in the drawings are not necessarily to scale relative to each other. Like reference numerals designate corresponding parts throughout the several views.

FIG. 1 is a diagram illustrating a side view of one embodiment of an image capture device.

FIGS. 2A-2D are a series of figures illustrating views of a video clip frame captured by an image capture device.

FIG. 3 is block diagram of components of an embodiment of an image capture device configured to capture frames of a video clip having orientation information.

FIG. 4 is a block diagram of one embodiment of a frame in a video clip with orientation information residing in the header.

FIG. 5 is a block diagram illustrating another embodiment wherein a frame with orientation information is displayed on a display device.

FIG. 6 shows a flow chart illustrating a process used by an embodiment of an image capture device for creating a frame of a video clip.

FIG. 7 shows a flow chart illustrating a process for providing orientation information for a frame of a video clip.

### DETAILED DESCRIPTION

In some embodiments of the present invention, image orientation information is provided for a video clip. One embodiment of the present invention incorporates orientation information into the header of each frame of a video clip. The orientation information corresponds to the orientation of the video image capture device at the time of frame capture. In some other embodiments the orientation information is incorporated into other suitable locations of the frame data.

A video clip, as used herein, refers to a series of time-related still images successively captured at sufficiently short intervals of time between each frame such as when the series of captured still images are later displayed in a continuous, sequentially successive manner, the viewer discerns the displayed images as a continuous display wherein movement of objects is discernable as a continuous, smooth motion. That is, the viewer views a video (rather than a single still image).

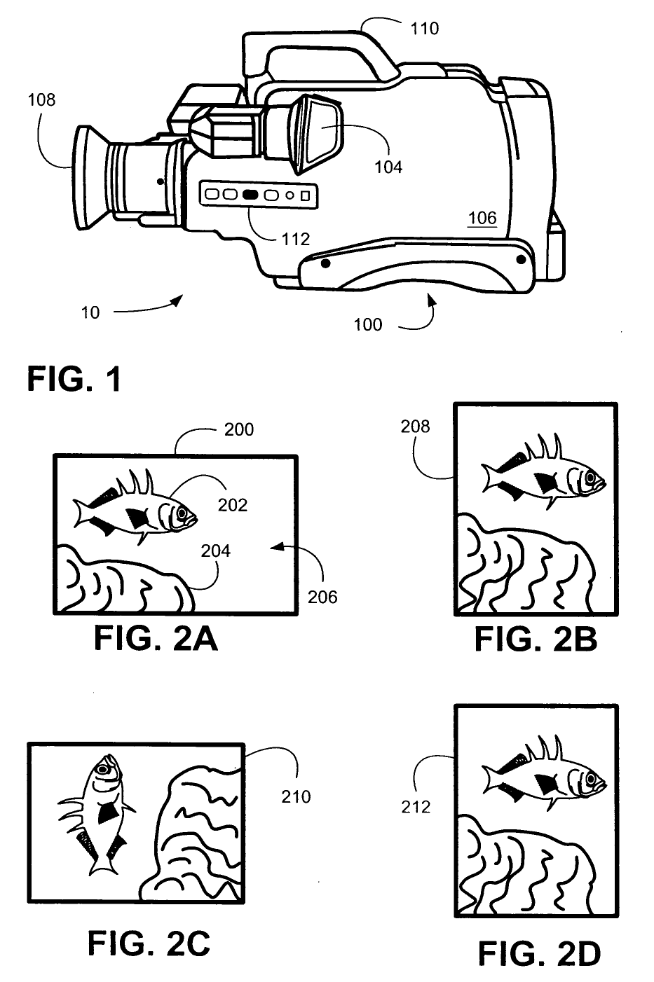

FIG. 1 is a diagram illustrating a side view 10 of one embodiment of an image capture device 100. For convenience, the image capture device 100 is illustrated as a generic type of video image capture device. Embodiments of the present invention may be implemented in any device configured to generate video clips, such as, but not limited to, a digital camera configured to capture either still images or video clips. It is understood that embodiments of the present invention apply equally to other types of video capture devices. Furthermore, other embodiments apply to other electronic devices that display videos, such as cellular telephones, personal device assistants, portable computers, table-top displays, televisions, radars, sonars and fish-finding devices. Image capture device 100 includes display 104, body 106, lens 108, optional handle 110 and controls 112.

FIGS. 2A-2D are a series of figures illustrating views of a video clip frame captured by an image capture device 100 (FIG. 1). FIG. 2A illustrates a frame 200 revealing a fish 202 swimming over a coral head 204. It is understood that the image capture device 100 is configured to operate underwater in this exemplary situation. Immediately in front of fish 202 and coral head 204 is a region of water 206 that may not be of particular interest to a viewer. Accordingly, the user of image capture device 100 may rotate the image capture device 100 by ninety degrees (90°), thereby capturing a video clip of the fish 202 in a portrait orientation, as illustrated in the frame 208 of FIG. 2B.

During later viewing, on display 104 (FIG. 1) or on a display of another device, in the absence of orientation as information provided by certain embodiments of the present invention, the frame 210 (FIG. 2C) would be displayed on its side as a landscape oriented image. However, the viewer of the frame 210 may not appreciate that the fish 202 is displayed with a 90° rotation from the original orientation during image capture. That is, the viewer may improperly perceive that the fish 202 is swimming in an upwardly direction along coral head 204 because there are no reliable visual cues that would indicate true orientation of the frame.

When frames are captured in accordance with certain embodiments of the present invention, orientation information is included with each frame of the video clip. FIG. 2D illustrates the rotation of the frame 210 (FIG. 2C) by 90° such that the orientation of the displayed frame 212 corresponds to the true orientation of the fish 202 and the coral head 204 when the video clip was captured.

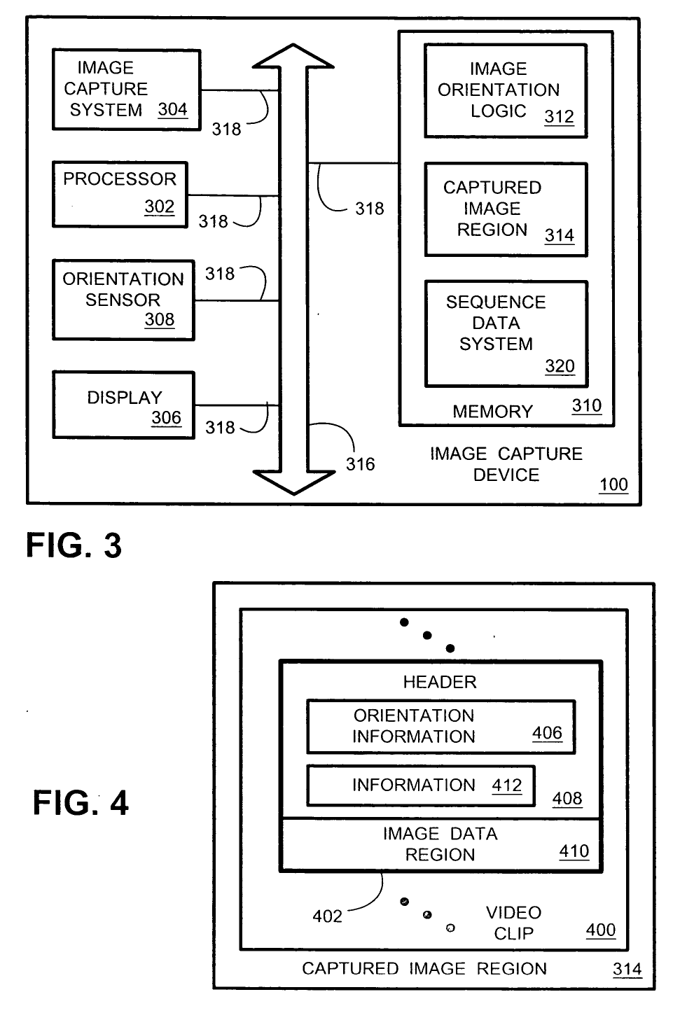

FIG. 3 is block diagram of components of an embodiment of an image capture device 100 configured to capture frames of a video clip having orientation information. Image capture device 100 includes processor 302, image capture system 304, display 306, orientation sensor 308 and memory 310. Memory 310 includes regions for image orientation logic 312, captured image region 314 and sequence data system 320. Sequence data system 320 provides data that is indicative of the relative position of each frame in a video clip.

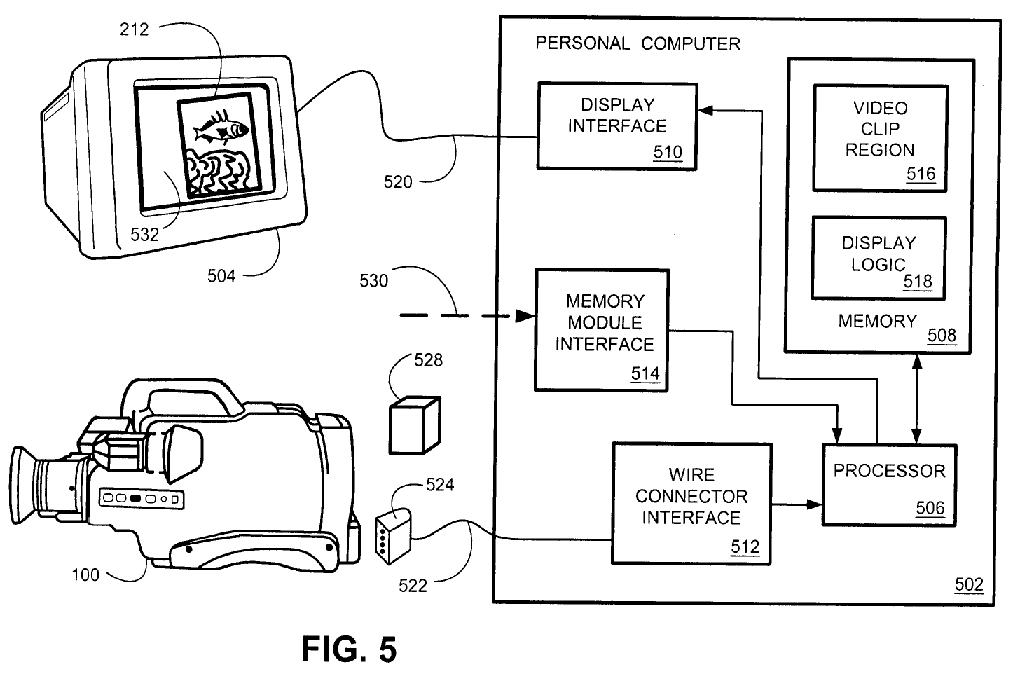

For convenience, image orientation logic 312 and captured image region 314 are illustrated as residing in a single memory 310. In other embodiments, image orientation logic 312 and captured image region 314 reside in separate memories. For example, image capture device may be configured to store captured images and video clips on a separate memory element 528 (FIG. 5) that is removable from the image capture device 100. Any suitable formatted detachable memory element 528 configured to store at least data corresponding to captured images and video clips may be used.

Processor 302, image capture system 304, display 306, orientation sensor 308 and memory 310 are coupled to communication bus 316 via connections 318, thereby providing connectivity between the above-described components. In alternative embodiments of image capture device 100, the above-described components are connectivley coupled to each other in a different manner than illustrated in FIG. 3. For example, one or more of the above-described components may be directly coupled to processor 302, or may be coupled to processor 302 via intermediary components (not shown).

As a video clip is captured by image capture device 100, frames are stored in the captured image region 314. The sequentially ordered plurality of frames of a video clip can then be played back in sequential order for viewing on display 306. Or, a single frame may be displayed.

When a video clip is captured by image capture device 100, processor 302 executes image orientation logic 312. As the image capture system 304 captures a frame of the video clip, orientation sensor 308 communicates information corresponding to the orientation of the image capture device 100. Using the image orientation logic 312, processor 302 associates the orientation information corresponding to the orientation of the image capture device 100 with the corresponding frame by incorporating the orientation information into the frame as data.

FIG. 4 is a block diagram of one embodiment of a frame 402 in a video clip 400 with orientation information 406 residing in the header 408. Header 408 includes other information 412 corresponding to the captured image residing in the image data region 410 of frame 402. For example, information 412 specifying location of frame 402 in a plurality of sequentially ordered frames of a video clip would reside in header 408.

As frame 402 is selected for viewing on a display, the orientation information 406 is retrieved such that the displayed frame 402 is displayed with an orientation corresponding to the orientation of the image capture device (FIGS. 1 and 3) at the time the frame was captured. In another embodiment, the reorientation of the frame 402 during display is optional.

FIG. 5 is a block diagram illustrating an embodiment of a processing unit, such as a personal computer 502 or the like, wherein a frame 402 with orientation information 406 (FIG. 4) is displayed on a display device 504. An exemplary embodiment of personal computer 502 includes a processor 506, a memory 508, a display interface 510, a wire connector interface 512 and a memory module interface 514. Memory 508 further includes video clip region 516 where at least one video clip 400 (FIG. 4) resides, and display logic 518. Memory 508 may also contain other data, logic and/or information used in the operation of personal computer 502, however such data, logic and/or information are described herein only to the extent necessary to describe certain embodiments of the present invention.

Personal computer 502 is illustrated as being coupled to a display device 504, via connection 520, so that frames 402 (FIG. 4) captured by embodiments of image capture device 100 (FIGS. I and 3) can be viewed on display device 504 with an orientation corresponding to the orientation of the image capture device 100 at the time the video clip was captured. In other embodiments, display device 504 is an integral component of personal computer 502. Furthermore, this embodiment may be implemented on any suitable device configured to display frames of a video clip.

Video clip region 516 is configured to store captured images and video clips received from image capture device 100. In one embodiment of image capture device 100, image capture device 100 transfers captured video clips to personal computer 502 via a hard wire connection 522. Connection 522 is coupled to a plug-in attachment 524. Plug-in attachment 524 is configured to connect to a corresponding plug-in interface on the image capture device 100. The user of image capture device 100 simply connects plug-in attachment 524 to image capture device 100, thereby establishing connectivity between image capture device 100 and personal computer 502. The user then instructs personal computer 502 and/or image capture device 100 to transfer captured video clips from image capture device 100 into the video clip region 516. In another embodiment, image capture device 100 and personal computer 502 communicate data wirelessly, as for example, but not limited to, Bluetooth® wireless communication technology.

In another embodiment, captured video clips are stored in detachable memory element 528. When capturing video clips with image capture device 100, memory element 528 is coupled to image capture device 100 through a suitable interface. Captured video clips are transferred to personal computer 502 by removing memory element 528 from image capture device 100 and coupling memory element 528 to memory module interface 514. Typically, a convenient coupling port or interface (not shown) is provided on the surface of personal computer 502 such that memory element 528 is directly coupled to personal computer 502, as illustrated by dashed line path 530. Once memory element 528 is coupled to memory module interface 514, video clips are transferred into the video clip region 516.

Display logic 518 is configured to retrieve a frame 402, determine orientation of the frame 402 based upon the orientation information 406 (FIG. 4), and display the oriented frame 402 on display 532 residing in the display device 504. The frame 402 may be retrieved from the video clip region 516, or directly from memory element 528, or directly from image capture device 100 over wire connection 522, depending upon the embodiment.

In other embodiments, the orientation information is stored in another convenient location of frame 402 (FIG. 4). For example, the orientation information may be saved after the header as a separate file within frame 402, saved as a separate file associated with frame 402, saved in the image data region 410, or saved as part of another file.

Any suitable orientation sensor 308 (FIG. 3) may be employed by embodiments of image capture device 100 (FIGS. 1 and 3) to provide the orientation information of a frame. One embodiment employs a sensor that is configured to indicate whether the image capture device is oriented in a portrait orientation or a landscape orientation at the time of image capture. Such information may indicate a left portrait or a right portrait orientation, depending upon the direction that the image capture device 100 is turned. Another sensor 308 may be configured to provide information that the image capture device is upside down.

Another device may include a radio frequency (RF) based system, such as a geographic positioning system (GPS). A plurality of RF signals are received such that orientation of the digital image capture device 100 at the time of frame capture is determined. Another device may be configured to sense the angular orientation of the digital image capture device 100 at the time of image capture such that an angle is provided to indicate orientation of the frame 402. Such orientation sensors 308 generate and communicate one or more orientation information signals to processor 302.

Furthermore, it is understood that the orientation sensor 308 may be comprised of a plurality of individual sensors working in conjunction to determine orientation information for a frame. For example, but not limited to, a first sensor may provide left portrait information when the image capture device 100 is rotated into a left portrait orientation, and a second sensor may provide right portrait information when the image capture device 100 is rotated into a right portrait orientation.

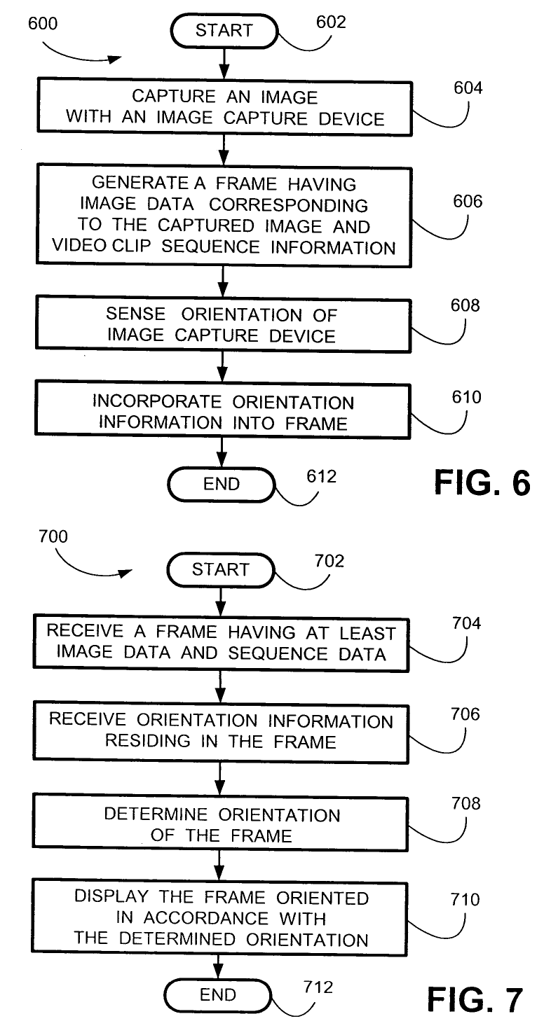

FIG. 6 shows a flow chart 600 illustrating a process used by an embodiment of image capture device 100 (FIGS. 1 and 3) for creating a frame of a video clip. The flow chart 600 shows the architecture, functionality, and operation of an embodiment for implementing the image orientation logic 312 (FIG. 3). FIG. 7 shows a flow chart 700 illustrating a process for providing orientation information for a frame of a video clip. The flow chart 700 shows the architecture, functionality, and operation of an embodiment for implementing the image orientation logic 312 (FIG. 3) or the display logic 518 (FIG. 5). Alternative embodiments implement the logic of flow charts 600 and/or 700 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIGS. 6 and/or 7, or may include additional functions. For example, two blocks shown in succession in FIGS. 6 and/or 7 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention

The process for creating a frame of a video clip begins at block 602. At block 604, an image is captured with an image capture device 100 (FIGS. 1 and 3). As understood herein, the captured image is one of a series of sequentially arranged images of a video clip. Accordingly, the frame is generated with information identifying the relative location of the captured image in the video clip as shown at block 606. At block 608 orientation of the image capture device at the time the image is captured is sensed. At block 610, the orientation information is incorporated into the frame. The process ends at block 612.

The process for displaying a frame based upon orientation information within the frame begins at block 702. At block 704, a frame from a plurality of serially sequenced frames corresponding to a video clip is received, the frame having at least image data and sequence data corresponding to an image captured by an image capture device. At block 706, orientation information residing in the frame is received. At block 708, the orientation of the frame is determined, wherein the orientation of the frame corresponds to the orientation of the image capture device at the time the image was captured. At block 710, the frame oriented in accordance with the determined orientation is displayed. The process ends at block 712.

Embodiments of the invention implemented in memory 310 (FIG. 3) and/or memory 508 (FIG. 5) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of implementations. Many variations and modifications may be made to the above-described embodiments. All such modifications and variations are intended to be included herein within the scope of this disclosure and protected by the following claims.

1. A video system comprising:
an image capture system configured to capture a plurality of frames of a video clip;
a sequence data generating system for generating data indicative of frame position of each of the plurality of frames;
an orientation sensor configured to provide orientation information for each of the plurality of frames at the time each frame is captured; and
a processor configured to incorporate the orientation information and sequence data into each frame.

2. The system of claim 1, wherein the orientation information resides in a frame header of each frame.

3. The system of claim 2, further comprising a memory configured to receive each frame wherein the orientation information resides.

4. The system of claim 1, further comprising a display configured to display each frame using the orientation information, such that the displayed frame is oriented the same as an orientation of the image capture system when the frame was captured.

5. A method for creating a frame of a video clip, the method comprising the steps of:
capturing an image with an image capture device;
generating a frame having at least image data corresponding to the captured image and sequence data indicative of a frame position in the video clip;
sensing an orientation of the image capture device at the time the image is captured; and
incorporating the orientation information corresponding to the sensed orientation into the frame.

6. The method of claim 5, further comprising repeating the steps of claim 6 to capture a plurality of serially sequenced frames corresponding to the video clip.

7. The method of claim 5, wherein the step of incorporating the orientation information comprises incorporating the orientation information into a header of the frame.

8. The method of claim 5, wherein the step of incorporating the orientation information comprises incorporating the orientation information into the frame as a file.

9. The method of claim 5, wherein the step of incorporating the orientation information comprises incorporating the orientation information into the image data.

10. The method of claim 5, further comprising the step of saving the frame to a memory comprising a plurality of serially sequenced frames corresponding to the video clip.

11. A method for displaying a frame of a video clip, the method comprising the steps of:
receiving the frame having at least image data and sequence data corresponding to an image captured by an image capture device;
receiving orientation information residing in the frame;
determining an orientation of the frame, the orientation of the frame corresponding to the orientation of the image capture device at the time the image was captured; and
displaying the frame oriented in accordance with the determined orientation.

12. The method of claim 11, further comprising the step of selecting the frame from a plurality of serially sequenced frames corresponding to the video clip.

13. The method of claim 11, further comprising the step of receiving the orientation information from a header of the frame.

14. The method of claim 11, further comprising the step of retrieving the frame from a memory.

15. The method of claim 11, further comprising the steps of:
communicating the frame from an image capture device to a processing device; and
displaying the frame on a display coupled to the processing device.

16. The method of claim 11, further comprising displaying the frame on a display coupled to the image capture device.

17. A system for providing orientation information for frames of a video clip, comprising:
means for capturing an image;
means for generating a frame having at least image data corresponding to the captured image and sequence data, wherein the frame is one of a plurality of serially sequenced frames corresponding to the video clip;
means for sensing an orientation of an image capture device at the time the image is captured;
means for incorporating the orientation into the frame; and
means for storing the frame with the orientation in a memory.

18. The system of claim 17, further comprising a means for generating orientation information from the orientation of the image capture device such that the orientation information is incorporated into the frame.

19. The system of claim 18, wherein the means for incorporating comprises means to store the orientation information in a header of the frame.

20. A computer-readable medium having a program for displaying a frame of a plurality of serially sequenced frames corresponding to a video clip, the program comprising logic configured to perform the steps of:
retrieving the frame from a memory, the frame having at least image data corresponding to a captured image that was captured by an image capture device and sequence data;
receiving orientation information residing in the frame;
determining an orientation of the frame, the orientation of the frame corresponding to the orientation of the image capture device when the image was captured; and
displaying the frame in accordance with the determined orientation.

21. A computer-readable medium having a program for providing orientation information for a frame of a video clip, the program comprising logic configured to perform the steps of:
receiving information from an image capturing system, the information corresponding to a captured image;
generating a frame having at least image data and sequence data corresponding to the captured image, wherein the frame is one of a plurality of serially sequenced frames corresponding to the video clip;
sensing an orientation of an image capture device at the time the frame is generated; and
incorporating the orientation into the frame.

22. A video clip comprising:
a first frame comprising image data, video sequence data and image orientation data; and;
a second frame comprising second image data, second video sequence data and second image orientation data, the second frame serially sequenced immediately behind the first frame.
